(19) United States
(12) Patent Application Publication
(10) Pub. No.: US 2014/0034180 A1
(43) Pub. Date: Feb. 6, 2014

(54) SYSTEM FOR RELIEVING STRESS AT PIPE CONNECTIONS USING EXTERNAL SLEEVE

(71) Applicant: MAKAI OCEAN ENGINEERING INC., Kailua, OH (US)

(72) Inventors: Joseph Charles VAN RYZIN, Kailua, HI (US); Steven Emanoel Rizea, Orlando, FL (US); Adam Norbert Landherr, Honolulu, HI (US)

(73) Assignee: MAKAI OCEAN ENGINEERING INC., Kailua, HI (US)

(21) Appl. No.: 14/046,744

(22) Filed: Oct. 4, 2013

Related U.S. Application Data
(62) Division of application No. 13/212,313, filed on Aug. 18, 2011.
(60) Provisional application No. 61/375,751, filed on Aug. 20, 2010.

(51) Int. Cl. F16L 3/12

(52) U.S. Cl. CPC F16L 3/12
USPC 138/172

(57) ABSTRACT

A pipe attachment assembly for attaching a pipe to another structure so stresses are reduced within the assembly includes a sleeve positioned outside the pipe which is composed of a material stronger than the pipe material, and an elastomeric bonding material which fills a gap between the pipe and the sleeve. The elastomeric bonding material transfers forces which are externally imposed on the pipe to the sleeve. This reduces bending, compression, tension, or torsion of the pipe in response to external forces, which in turn reduces the risk of a pipe failure at or near the termination or a breach where the pipe forms a joint with other pipes or containers. Various configurations may further improve the transfer of shearing stresses from the pipe to the sleeve, for example varying the width and/or the shear modulus of the elastomeric bonding material along the length of the pipe.

### RELATED APPLICATIONS

The present application is a divisional application of U.S. Non-Provisional patent application Ser. No. 13/212,373 entitled “Steel-HDPE Epoxy Bonded/Bend Limiter” filed Aug. 18, 2011, which claims the benefit of priority to U.S. Provisional Patent Application No. 61/375,751 entitled “Steel-HDPE Epoxy Bonded Bend Limiter” filed Aug. 20, 2010, the entire contents of both of which are hereby incorporated by reference.

### FIELD

The present invention relates to flexible pipe structures used for the transport of liquids or gases, and more particularly to a system and method for managing stresses in pipe connections.

### BACKGROUND

In many industrial, power plant, and shipbuilding situations pipes are rigidly connected to large structures including other pipelines through welds or bolted flanges. In such structural assemblies, loads applied to the pipe are concentrated near the structural attachment or termination end of the pipe. In addition, the strength of the pipe at the mechanical connection is often weaker than the parent pipeline. Therefore loads on the pipe often result in failures at the connection.

### SUMMARY

The various embodiments provide structural systems and methods for relieving stress at pipeline connections including flanges. The various embodiments include positioning a rigid sleeve around or within the portion of the pipe close to attachment to the other structure and filling the volume between the pipe and the sleeve with a deformable material such as epoxy that adheres to both the sleeve and the pipe. The sleeve may be conical in shape, such as a frustum, or parabolic in shape. The sleeve may be positioned around the outside of the pipe such as to form a collar. Alternatively, the sleeve may be positioned within the inside of the pipe such as to form a narrowed portion. Under tensile, torsional or bending loads in the pipe the interaction of the pipe with the sleeve through the epoxy reduces the stress concentrations in the vicinity of the pipe attachment. The embodiments are particularly applicable to flexible pipes, including pipes made from high-density polyethylene (HDPE). The embodiments enable bolting a flexible pipe to a large structure or bolting two sections of flexible pipes together so that the entire assembly may be bent without the connection becoming the weak link, thereby reducing the chance of pipe failure at the connection.

### BRIEF DESCRIPTION OF THE DRAWINGS

Features of the present system and method are illustrated by way of example and not limited in the following figure(s). In the figures, like numerals indicate like elements. In some cases, elements in two figures which are similar or analogous, but represent somewhat different embodiments or different instances of the same element, may be represented by similar numbers with suffixes (for example, 110, 110e, 110c, 110.1, 110.2, etc.).

FIG. 1A is a cross sectional view of a pipe attachment assembly according to an embodiment.

FIGS. 1B and 1C are diagrams illustrating structure and force references related to the pipe attachment assembly shown in FIG. 1A.

FIGS. 2A and 2B are longitudinal and lateral cross sectional views of a pipe attachment assembly according to an embodiment.

FIG. 3A is a cross sectional view of a pipe attachment assembly according to another embodiment.

FIG. 3B is a detail of a feature of the epoxy of the pipe attachment assembly illustrated in FIG. 3A.

FIGS. 4A and 4B are longitudinal and lateral cross sectional views of a pipe attachment assembly according to the embodiment shown in FIG. 3A.

FIG. 5 is a cross sectional view of a pipe attachment assembly according to another embodiment.

FIGS. 6A and 6B are longitudinal and lateral cross sectional views of a pipe attachment assembly according to an embodiment.

FIG. 7A is an illustration of an embodiment assembly and FIG. 7B is a graph of a bonding material hardness along the length of the pipe shown in FIG. 7A.

FIG. 8 is a cross sectional view of a pipe attachment assembly according to another embodiment.

FIG. 9 is a cross sectional view of a joint between two pipes with each pipe embodying a system for relieving pipe stresses at the connection according to an embodiment.

FIG. 10 is a cross sectional view of a pipe attachment assembly according to another embodiment.

FIG. 11A is an illustration of an embodiment assembly and FIG. 11B illustrates elements useful for modeling of distribution of shear stresses in the embodiment illustrated in FIG. 11A.

FIGS. 12A-12C illustrates alternative configurations of a reinforcing member generally referred to herein as a frustum.

FIG. 13 is a process flow diagram of an exemplary method for constructing a system for distributing shear stresses in a pipe.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims. Alternate aspects may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any aspect described herein as “exemplary” and/or “example” is not necessarily to be construed as preferred or advantageous over other aspects.

Pipes are key structural elements in many structures, including natural gas pipe systems, water pipes, and other applications. In many applications, pipes are made from high-density polyethylene (“HDPE”) which has lower strength and elastic modulus than steel and aluminum pipes, meaning that HDPE pipes are more flexible than steel or aluminum. In many applications the pipes are subject to strong forces, such as bending forces, compression forces, stretching forces, or torsional forces. These forces can lead to large stresses in the pipe in the vicinity of joints or connections between the pipe and other structures or other sections of pipe.

Polyethylene thermoplastic pipes are used in some offshore seawater intake or outfall applications. When an HDPE pipe is used for offshore seawater intakes, hydrodynamic forces can result in large axial forces or moments applied to the pipes. As a result, such pipes may bend with a bend ratio (the bend radius divided by the diameter of the pipe) of roughly 20 to 30. Such a high bend places large loads on the mechanical flanges used to connect long lengths of fused pipe to larger structures (such as tanks and plenum) or to other lengths of pipe. This can create severe strains in the flange stub end of the pipe, which can result in opening a gap between the lengths of pipe and the connected structure or other pipe length. In extreme cases, the bending forces can cause a failure in the HDPE pipe or fusion joints, which can cause the entire pipeline to sink. Pipes have failed at mechanical joints in the past, and the potential for failure appears to be more severe with large diameter pipes.

To alleviate this problem, the inventors have explored numerous solutions in the past. One approach involved adding external snug-fitting stiffener sleeves to the HDPE for about 1 to 2 diameters on either side of the flange. Modeling of this approach showed it to be ineffective because there is no shear capability between the outer sleeve and the HDPE. The high stress in the bent pipe is still applied fully to the stub end, and it is greatly distorted.

Another approach evaluated involved beefing up the stub ends, by using a heavier stub end which reduces the stress in the area of increased pipe thickness. Physical tests show much less distortion which could reduce the potential for opening of the flange. However, this approach introduces quality control and availability issues.

Another approach used by the inventors has been to insert a press-fit inner sleeve inside the pipe adjacent to the connection and to utilize an external clamp with a roughened inner surface that very tightly squeezes both the HDPE pipe and the internal sleeve. This approach squeezes the HDPE pipe between two stiff inner and outer cylinders and develops a frictional shear capacity between the steel clamp and the HDPE pipe. However, because of the extreme differences in the elasticity of steel and HDPE, the shear distribution between the clamp and the HDPE is not uniform: it is excessively high at the clamp edge furthest from the flanged connection. The stresses are not reliably relieved at the connection under repetitive pipe loading and this approach is expensive to fabricate.

To address the stress concentration problem in a manner that is superior to previously considered approaches the various embodiments include a rigid sleeve positioned about a pipe with the volume between the pipe and the sleeve element filled with epoxy. The pipe with the rigid sleeve is also referred to herein as a “reinforced pipe”, a “pipe attachment assembly,” a “pipe with a stress reliever element,” and a “pipe with a stress reliever for substantially uniform distribution of stress.” The elements taught herein apart from the pipe proper, and in particular the sleeve and the epoxy, may be referred to a “pipe bend limiter,” a “bend limiter,” or a “pipe stress relief element,” or by substantially similar terms.

Epoxy is an adhesive polymer formed from reaction of a “resin” with a “hardener”. Epoxy has a wide range of applications, including as a general purpose adhesive. Epoxy is also referred to in this document as an “elastic potting material” (“potting” referring to a material which is pourable at least in initial use or application, and which has sufficient flow properties to fill relatively small voids, gaps, pockets, etc.); and is also referred to herein as an “elastomeric bonding material” (“elastomeric” referring to a material that is able to resume its original shape when a deforming force is removed). When used during a manufacturing process, an epoxy typically starts as relatively fluid though viscous, but then permanently hardens to a relatively more solid form, though a form still capable of bending, compressing and stretching.

In embodiments described herein, an epoxy is used to transfer a shear stress or force from a flexible polymer pipe to a rigid sleeve. In an embodiment, the epoxy is configured to transfer a pressure of approximately 250 pounds per square inch of pipe surface. There are epoxy and elastic potting materials that will adhere to HDPE and to the sleeve.

While the embodiments are described with reference to pipes made from HDPE; however, the embodiments may be applied to other types of flexible pipes (i.e., pipes with a relatively low elastic modulus).

As disclosed herein, a bend limiter is used to remove stress from a pipeline at a flange of the pipe. The bend limiter is made in part from a sheet of material, referred to as a sleeve, which is stiffer than the HDPE. The sleeve may be a metal, which may include for example and without limitation steel, titanium, or aluminum, or related alloys. The sleeve may also be a fiber glass.

Another element of the bend limiter is an epoxy which adheres to both the bend limiter and the HDPE pipe, and transfers forces from the HDPE pipe into the bend limiter via shear stress, thereby greatly lowering the stress in the HDPE at the stub end.

The various embodiments redistribute stress and strain in the vicinity of an HDPE pipe mechanical joint, and thus improve reliability during high loading conditions—particularly high bending. The embodiments reduce the high stress and strain that occur at stub ends in HDPE pipe attached to other structures (e.g., a tank or another pipe). An embodiment could be employed as a means for attaching to an HDPE pipe termination or mid-section for the purpose of adding wall anchors, pulling points, etc.

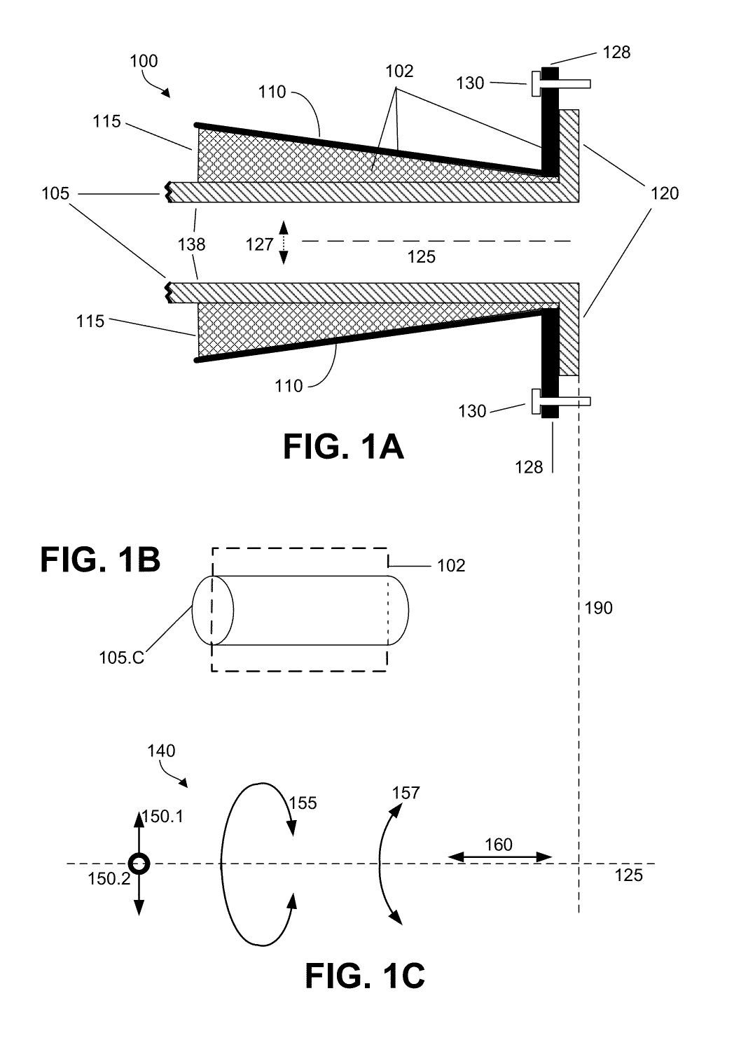

FIG. 1A shows a longitudinal cross-sectional view of a pipe 105 encircled with a sleeve 110 and epoxy fill 115 which together form a pipe attachment assembly 100. FIG. 1B illustrates a cylinder 105.c representing the pipe element only, illustrated in a three-dimensional view. Planar surface 102 illustrates a longitudinal plane bisecting the pipe 105.c.

In the cross-sectional view shown in FIG. 1A, the pipe 105 encompasses an inner space with a longitudinal axis 125, the inner space typically being intended for use for the transport of liquids or gases. A radial direction 127 is also associated with the pipe 105, as indicated in FIG. 1A-1C by dashed line 127 which is orthogonal to the long axis 125.

In the illustrated embodiment, the pipe 105 terminates with a flange 120. The end of the pipe 105 with the flange 120 is also referred to herein as the “stub end of the pipe,” or simply the “stub end.”

Starting at or near the flange 120 and extending for some length along the end of the pipe 105 is an epoxy or elastic potting material 115 which in an embodiment is bonded continuously to the surface of the pipe 105 and completely covers the circumferential length of pipe 105 from the flange 120 out to some length along the pipe which terminates at a designated endpoint 138 along the length of the pipe 105. The epoxy 115 will have a high shear strength, meaning it can withstand stretching and bending forces without the epoxy tearing or cracking For applications with large HDPE pipes 105, the shear strength of the epoxy 115 may typically be on the order of 300 psi or greater. At the same time, the epoxy 115 has a low shear modulus (a measure of how stiff the epoxy is relative to torsion and twisting) and so will significantly distort, thus allowing the HDPE pipe 105 to move relative to a rigid sleeve 110 (described further immediately below).

In the pipe attachment assembly 100 of FIG. 1, the elastomeric potting material 115 is completely external to the pipe 105. The width of the epoxy 115 varies along the length of the pipe 105, being thinnest at or near the flange 120 and getting progressively thicker progressing along the length of the pipe away from the flange 120, reaching a maximum at or substantially near to the endpoint 138. In a pipe attachment assembly 100, the width of the epoxy 115 (i.e., the gap between the pipe 105 and the sleeve 110 increases linearly from the flange 120 to the endpoint 138. As discussed in more detail below, in various embodiments, the gap between the sleeve 110 and the pipe 105 may be varied and/or the epoxy shear modulus may be varied in order to cause the shear to be uniform and within the shear limits of the bond between the pipe and the epoxy. It should be noted that in the pipe attachment assembly there will be a bond shear strength between the epoxy and the pipe or sleeve, and there is a shear strength within the epoxy itself, which when exceeded, the material itself shears off internal to the epoxy. In general, if the epoxy's bond strength is 300 psi, then the epoxy's shear strength will be 300 psi or higher.

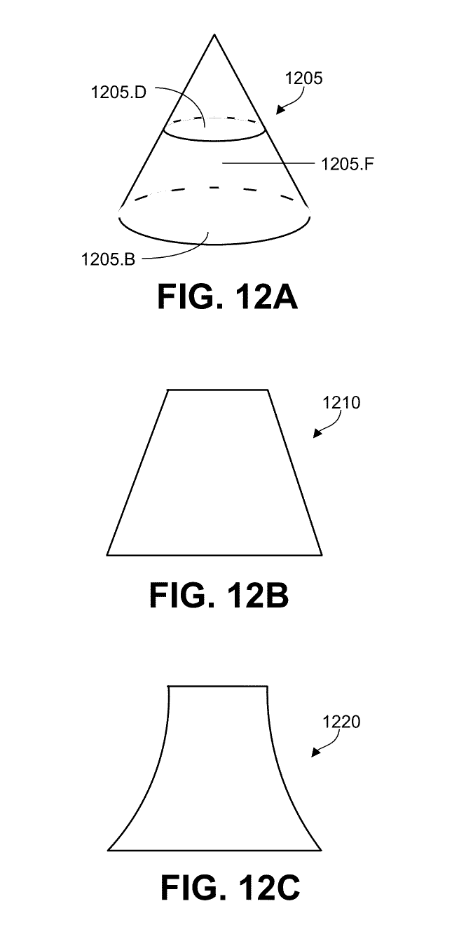

Immediately external to the epoxy 115, and bonded to the epoxy 115, is a rigid sleeve 110. The rigid sleeve 110 is made of a high elastic modulus material which is harder than the material of the pipe 105. For example the rigid sleeve 110 may be comprised of a metal or fiberglass. In an exemplary embodiment the rigid sleeve 110 is composed of a metal such as steel, titanium, or aluminum. As the rigid sleeve 110 is continuously bonded to the epoxy 115, the shape of the rigid sleeve 110 conforms to the shape of the outer surface of the epoxy 115. Since the epoxy 115 varies in width, the rigid sleeve 110 forms a frustum. A frustum shape is discussed further below with respect to FIG. 12. The rigid sleeve 102, epoxy 115, and sleeve flange 128 may be referred to together as a bend limiter 102 or, synonymously, as a pipe bend limiter 102.

The narrow or smaller diameter end of the frustum of the rigid sleeve 110 substantially coincides with the flange 120 of the pipe 105. The wide or larger diameter end of the sleeve 110 is longitudinally removed from the flange 120 of the pipe 105, substantially coinciding with or being near the endpoint 138.

This variation in width allows the present system and method to adjust for non-uniform relative movement between the HDPE pipe 105 and the sleeve 110. When the pipe 105 is loaded by a moment, torsion, tension or compression, the relative movement between the pipe 105 and the sleeve 110 is greatest at point 138 and is least near the flange 120. The variation in gap allows for a near-uniform shear in the epoxy 115 over the length of the sleeve 100 even when there is a non-uniform relative movement between the pipe 105 and the sleeve 110. Therefore, with a near uniform shear strain in the potting material 115, there is a near-uniform transfer of load from the pipe 105 into the sleeve 110 over the length of the epoxy 115.

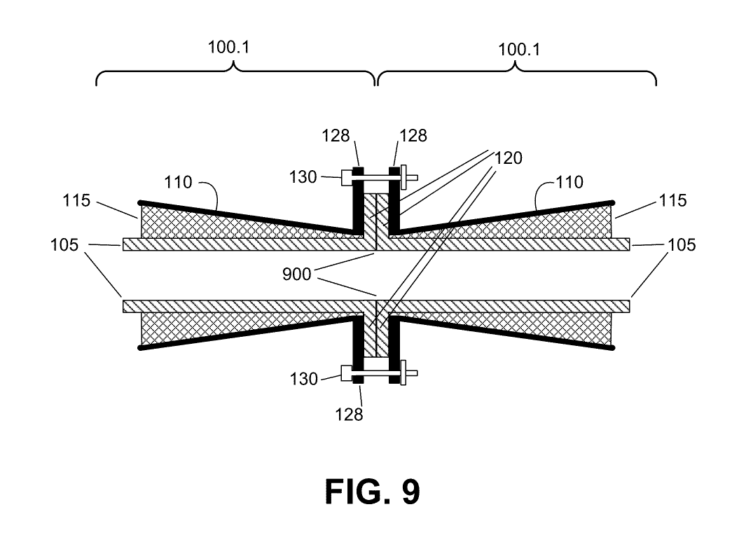

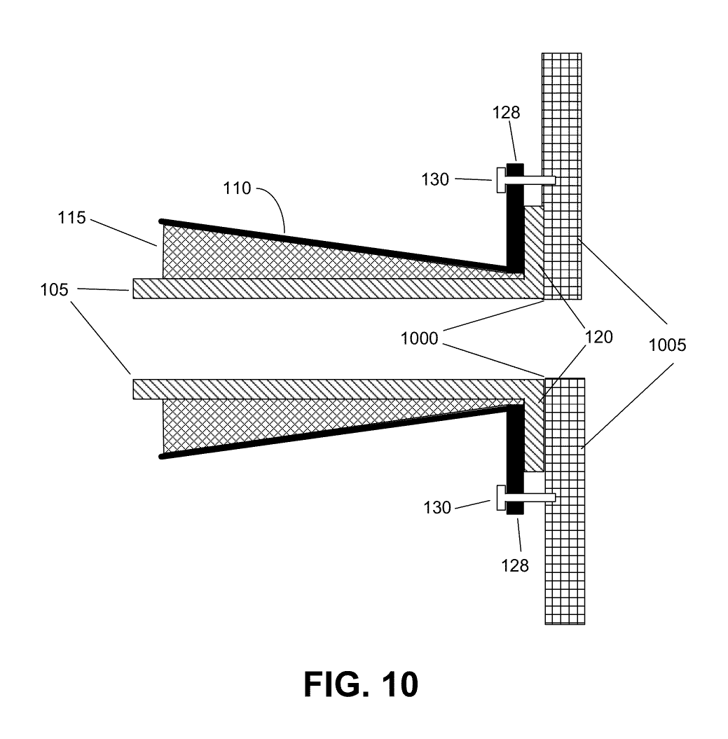

The illustrated pipe attachment assembly 100 includes a backup ring 128, also referred to as a “sleeve flange,” which serves as a base at the narrow end of the sleeve 110. The backup ring 128 is rigidly connected to the flange 120 (for example, by the pressure exerted on flange 120 as it is squeezed between backup ring 128 and a mating surface, not shown), ensuring that the sleeve 110 is rigidly connected at a joint which may be formed at the end of the pipe 105. The bolt 130, which may extend through the backup ring 128, may be used to connect an end of the pipe attachment assembly 100 to a mating surface (not shown in FIG. 1). The mating surface may be another pipe or may be a container or tank of some kind Joints formed between the pipe attachment assembly 100 and other elements are discussed further below with respect to FIGS. 9 and 10.

While illustrated in the figure as penetrating only through the backup ring 128, the bolt 130 may be configured to penetrate through the backup ring 128 and the flange 120. Also, other types of attachment mechanisms may be used, including positioning the flange 120 within structural layers of the structure which it is attached, and using rivets, screws and/or adhesives instead of bolts.

Also shown in FIG. 1C are forces and moments 140 to which the pipe 105 may be subject. These forces 140 are illustrated in relation to the central longitudinal axis 125 of the pipe 105 and the mating surface plane 190. Forces to which the pipe 105 may be subject include bending moments 150.1, 150.2 orthogonal to axis 125, shear forces 155 orthogonal to axis 125, axial forces 160 (compression and tension) along axis 125, and torsional moments 157 about axis 125.

Bending moments, tensile loads, and torsion moments result in stresses in the pipe 105. These shearing stresses, in turn, can induce a gap at an end of the pipe 105 where the flange 120 is mated to a mating surface (not shown in the figure). These stresses can result in pipe failure, such as flange cracking or bursting. The various embodiments solve this problem by enabling movement of the pipe 105 relative to the sleeve 110 resulting in a shear stress within the epoxy layer 115. The loads on the pipe 105 at or near the flange 120 are thus distributed via this shear stress in the epoxy 115 to the sleeve 110 over the full length of the epoxy 116, thereby uniformly reducing the stresses along the length of the pipe 105. In this way the risk of a gap formed between the flange 120 and a mating surface is reduced, and the risk of pipe failure at or near the flange 120 is reduced.

In an exemplary embodiment of the present system and method, the constant outer diameter of the pipe 105 may be somewhere between 12″ (0.3 meter) and 98.5″ (2.5 meter). In an embodiment, the thickness of the walls of the pipe 105 may be between about 0.5″ (1.3 cm) and 3″ (7.6 cm). In an embodiment, the length of the sleeve 110 from the base of the frustum to the top of the frustum may be 1 to 2 times the diameter of the pipe 105, or about 5′ to 15′ (1.5 meters to 4.5 meters). In an embodiment, the thickness of the rigid sleeve 110 may be approximately ¼″ (0.64 cm). In an embodiment, the epoxy 115 may vary in width along the length of the pipe from approximately 1/10″ (0.25 cm) at or near the flange 120 to approximately 1-2″ (2.5 to 5 cm) wide at or near its terminus (at or near point 138). The dimensions listed above are merely to serve as an illustrative example, and other embodiments with differing dimensions fall within the scope of the claims.

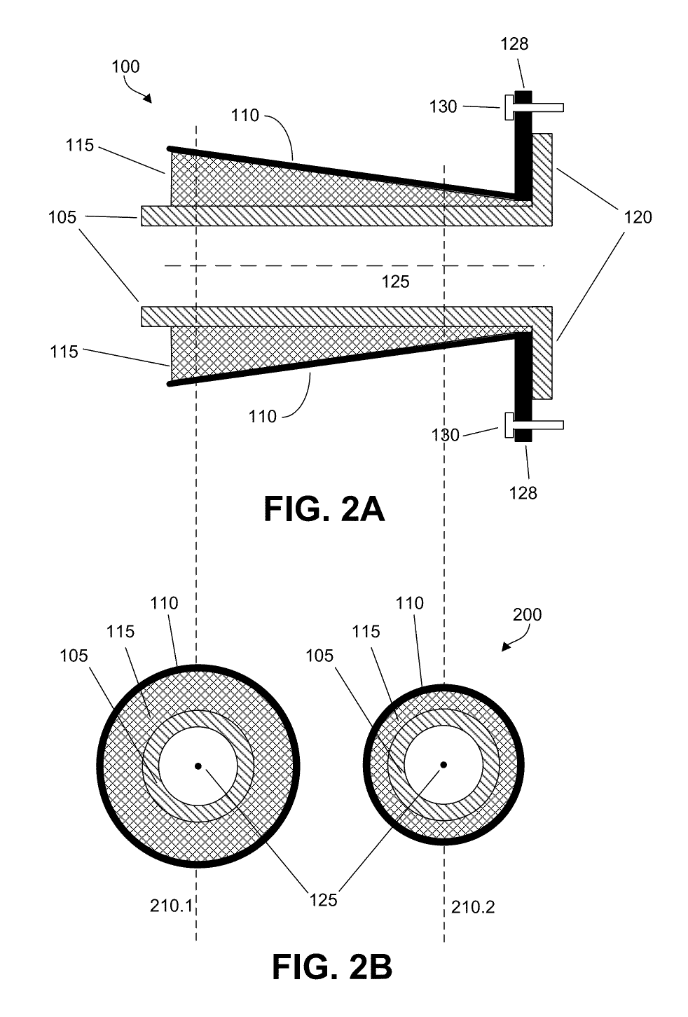

FIGS. 2A and 2B are longitudinal and lateral cross sectional views of a pipe attachment assembly 100 according to the embodiment shown in FIG. 1A. Cross sectional view 210.1 and cross-sectional view 210.2 are both orthogonal to the long axis 125 of the pipe 105.

Cross-sectional view 210.2 represents a lateral cross section through the pipe 105 at a location relatively closer to the flange 120, and cross-sectional view 210.1 represents a lateral cross section through the pipe 105 at a point or a distance relatively further from the flange 120. As can be seen, the cross sectional view 210.1 shows a wider portion of the epoxy 115 as compared to the narrower portion of the epoxy 115 shown in the cross-sectional view 210.2. Consequently the, sleeve 110, being exterior to the epoxy 115, has a wider diameter in the cross-sectional view 210.1 and a narrower diameter in the cross-sectional view 210.2.

The variation in width of the epoxy 115, and the corresponding variation in the diameter of the sleeve 110 along the length of pipe 115, which results in the sleeve 110 being a frustum with a narrow end close to the flange 120 and a wide end removed at some distance from the flange 120, further results in a substantially more even and continuous distribution of shear stresses along the end of the pipe attachment assembly 100 which result from the primary forces 140 on the pipe 105.

The shear stress distribution between the pipe 105 and the sleeve 110, carried through the epoxy 115, can be controlled by: varying the thickness of the epoxy 115 layer and thus the shape of the sleeve 110, varying the shear modulus or stiffness of the epoxy 115; or by a combination of epoxy thickness variation and epoxy shear modulus variation. The objective of these variations is to have a near-uniform shear stress in the epoxy 115 and to not exceed the bond strength between the epoxy 105 and the sleeve 110, or to not exceed the bond strength between the epoxy 115 and the pipe 105. Providing a near-uniform shear stress in the epoxy 115 will result in uniformly distributed loads from the pipe 105 to the sleeve 110. Embodiments illustrating these variations are discussed further below.

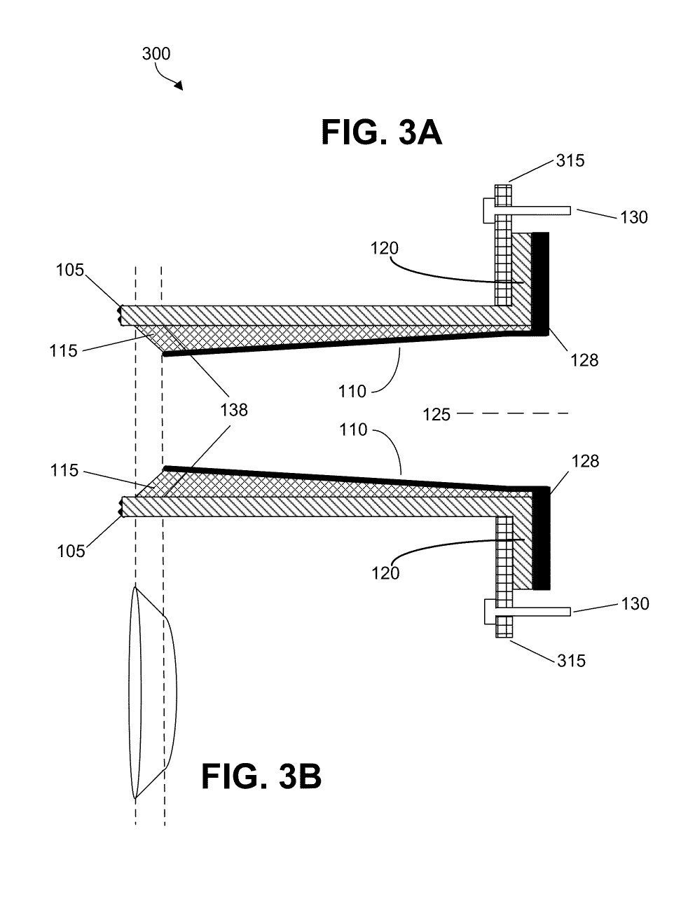

FIG. 3A illustrates an exemplary embodiment of a pipe attachment assembly 300. Many elements shown in FIG. 3A are the same or substantially similar to those described above with respect to the pipe attachment assembly 100, and a detailed description will not be repeated here. However the pipe attachment assembly 300 has the epoxy 115 bonded to the interior surface of the pipe 105. Further, the sleeve 110 is bonded to the interior surface of the epoxy 115. The result is that the interior sleeve 110 now has a frustum-shape with the narrow end of the frustum removed at some distance from the flange 120, substantially at or near point 138, and the wide base of the frustum in close proximity to the flange 120. A standard backup ring 315 may be employed to connect the pipe attachment assembly 300 to a mating surface (not shown).

As shown in FIG. 3B, the epoxy 115 of the pipe attachment assembly 300 also has a minor frustum-shaped base 310 at the end farthest removed from the flange 120 with the slope of the frustum so inclined so as to facilitate smooth flow of fluids within the interior of the pipe 105.

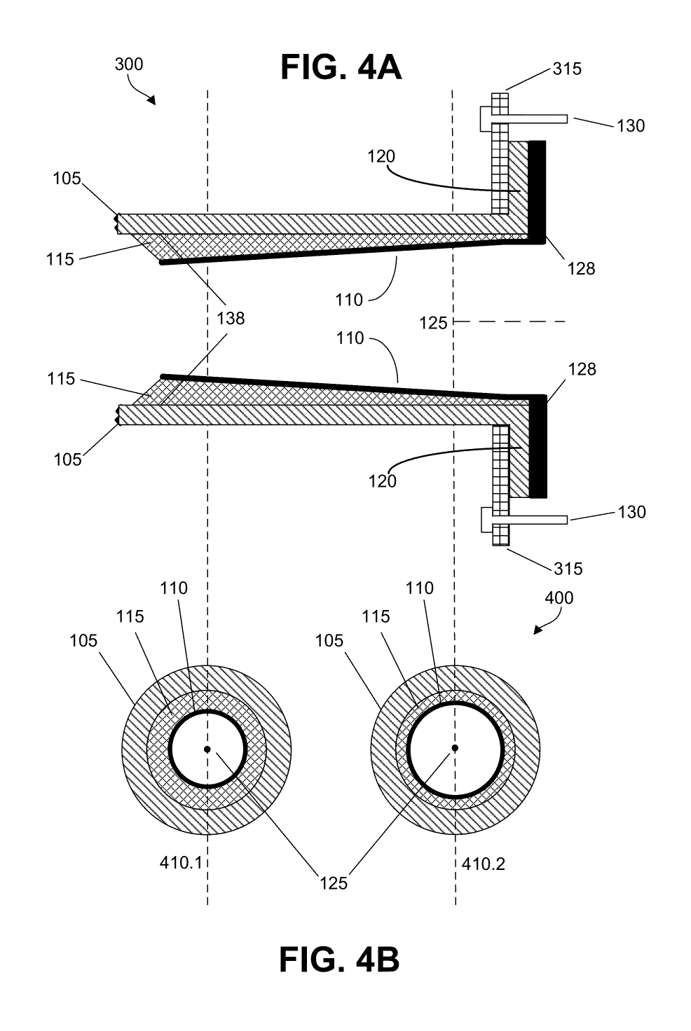

FIGS. 4A and 4B are longitudinal and lateral cross sectional views of the pipe attachment assembly embodiment shown in FIG. 3A. Cross sectional view 410.1 and cross-sectional view 410.2 are both orthogonal to the long axis 125 of the pipe 105.

Cross-sectional view 410.2 represents a cross section through the pipe 105 at a location relatively closer to the flange 120, and cross-sectional view 410.1 represents a cross-sectional view at a point or a distance relatively further from the flange 120. As can be seen, the cross sectional view 410.1 shows a wider portion of the epoxy 115 as compared to the narrower portion of the epoxy 115 shown in the cross-sectional view 410.2. Consequently, the sleeve 110, being interior to the epoxy 115, has a relatively narrower diameter in the cross-sectional view 410.1 and a relatively wider diameter in the cross-sectional view 410.2.

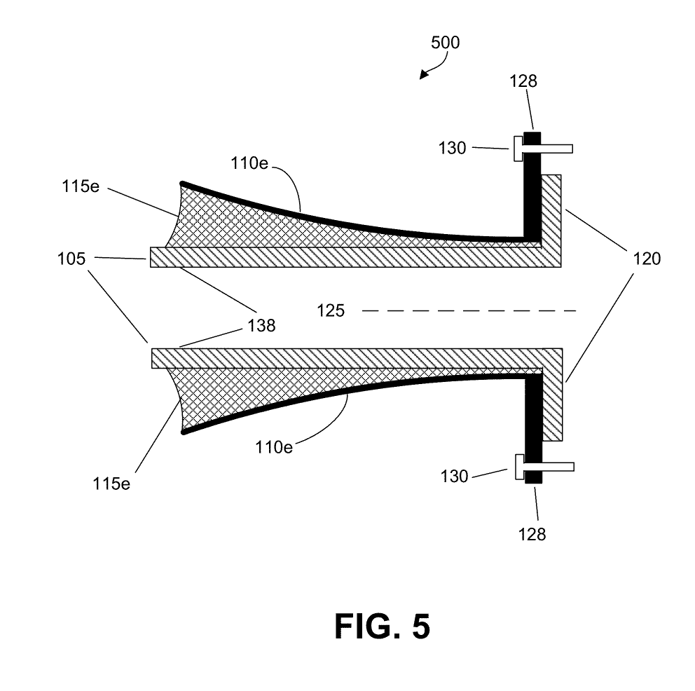

FIG. 5 illustrates another exemplary embodiment of a pipe attachment assembly 500. Many elements shown in FIG. 5 are the same or substantially similar to those described above with respect to the pipe attachment assembly 100, 300 and a detailed description will not be repeated here. However the pipe with bend limiter 500 has the epoxy 115e with a nonlinear variation in width starting from the flange 120 and extending along the length of the pipe 105 towards the point 138.

In one embodiment, the nonlinear variation may result in an exponential curvature of the surface of the epoxy 115e which is in contact with the sleeve 110e. In turn, the frustum formed by the sleeve 110e has a curvature along the length of the long axis 125, starting closer to the long axis 125 near flange 120 and curving away from the long axis 125 approaching the point 138. In an exemplary embodiment, the frustum of the sleeve 110e may have an exponentially shaped curvature along the direction of long axis 125.

To maximize the shear transfer loads (keeping an optimal high shear load along the entire epoxy-filled gap between the sleeve 110e and the HDPE pipe 105), it is an advantage to have the gap between the HDPE pipe 105 and the sleeve 110e be non-linear along the pipe axis 125. An exponential shape may be ideal; a truncated shape approximating the exponential shape may be the most practical to construct. The nonlinear variation in the width of the epoxy 115e, and the corresponding nonlinear variation in diameter of the sleeve 110e along the length of the pipe 115, contributes to a more even and continuous distribution of shear stresses 140 through the epoxy 115 and between the pipe 105 and the sleeve 110.

While FIG. 5 illustrates the epoxy 115e and sleeve 110e being external to the pipe 105, in an alternative embodiment the epoxy 115e and a curved frustum-shaped sleeve 110e may be positioned internal to the pipe 115.

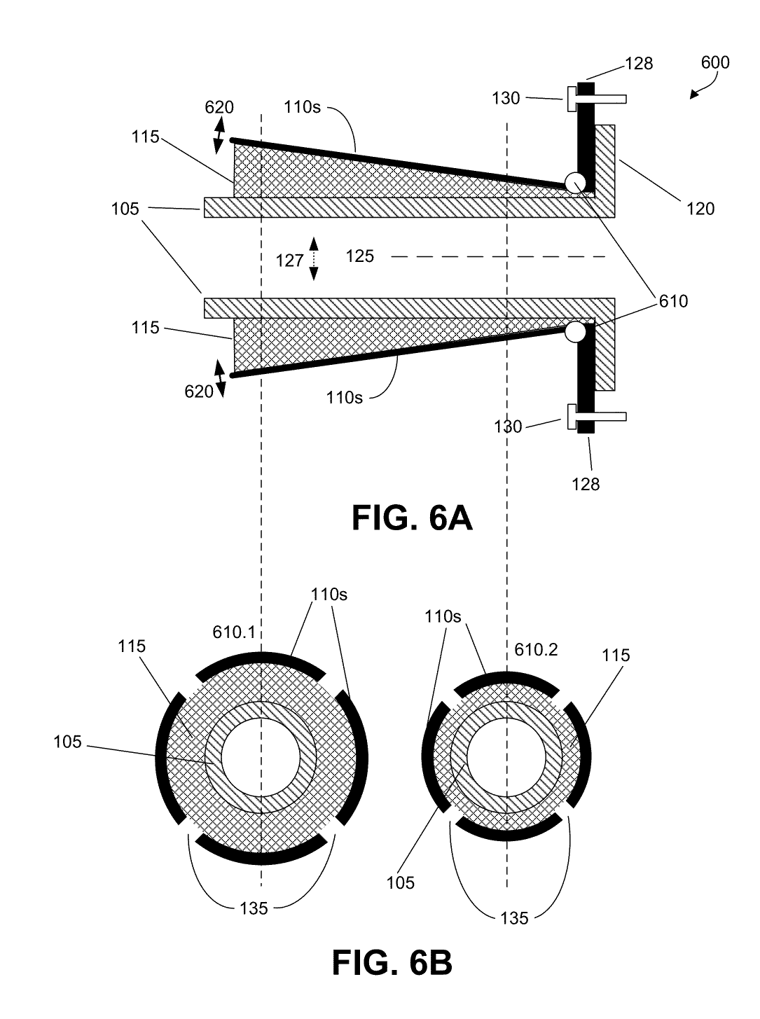

FIGS. 6A and 6B are longitudinal and lateral cross sectional views of a pipe attachment assembly according to an embodiment. Many elements shown in FIGS. 6A and 6B are the same or substantially similar to those described above with respect to the pipe attachment assembly 100, 300, 500, and a detailed description will not be repeated here. However, the pipe attachment assembly 600 illustrated in FIG. 6A includes a sleeve 110 with multiple sleeve sections 110s. The sleeve sections 110s run parallel with the long axis 125, but are separated from each other by longitudinal gaps 135 which run the length of the sleeve 110. While four sleeve sections 110s are shown as separated by four gaps 135, more or fewer sleeve sections and gaps may be employed as well. Also, the width of the gaps 135 shown is representational only, and gaps employed in practical application may be thinner or wider relative to the sleeve sections 110s.

Each sleeve section 110s may be attached to the backup ring 128 by a hinge 610. Each hinge 610 may be a flexible element which securely connects a sleeve section 110s to the backup ring 128 while permitting the sleeve section 110s to pivot at a respective hinge 610. Sleeve sections 110s thereby can expand or contract along a direction approximately orthogonal to the length of the sleeve section 110s, that is, in an approximately radial direction of the pipe 105 as suggested by arrows 620 in the figure. This, in turn, permits the sleeve 110 as a whole, which is comprised of its sleeve sections 110s, to expand or contract if the pipe 105 expands or contracts in a direction 127 orthogonal to axis 125. The pipe 105 may, for example, expand or contract radially due to thermal expansion or contraction, compression or stretching directed along the axis 125, or due to pressure of fluids within the pipe 105, or for other reasons.

Each sleeve section 110s still takes axial shear without distortion and passes the load through its respective hinge 610 to the backup ring 128.

The hinge 610 may be a barrel hinge, a piano hinge, a spring loaded element or elements, a flexible metallic strip, a flexible polymer, or other element or elements which permit flexing at the junction of the sleeve element 110s and the backup ring 128.

While FIGS. 6A and 6B illustrate the epoxy 115, the sleeve sections 110s, and the hinges 610 as being external to the pipe 105; in an alternative embodiment the epoxy 115, the sleeve sections 110s, and the hinges 610 may be internal to the pipe 115.

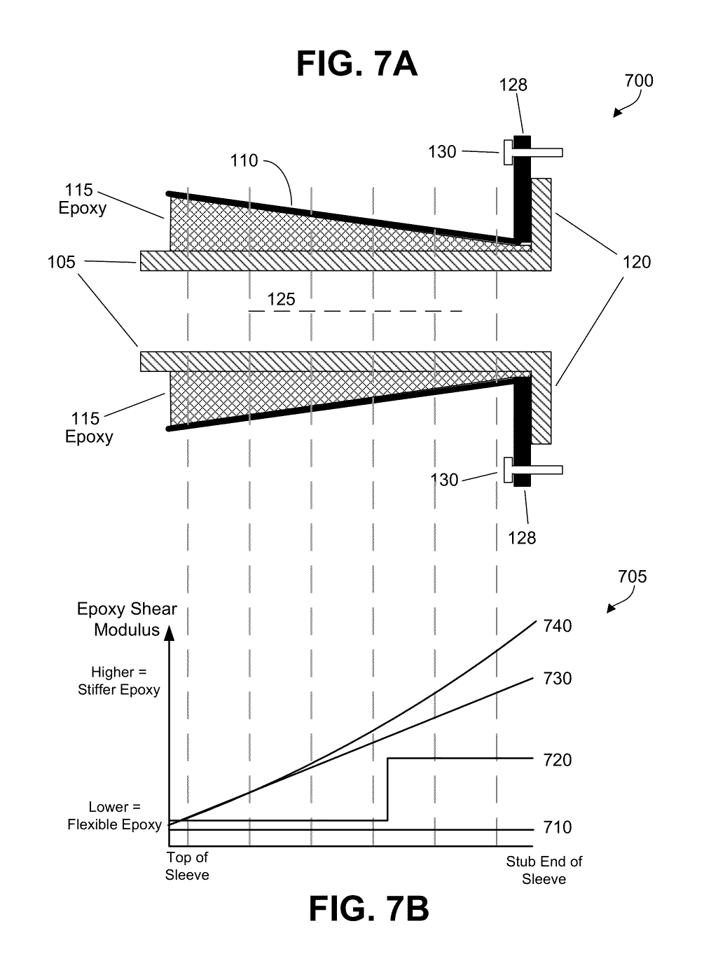

FIG. 7A is an illustration of an embodiment pipe attachment assembly and FIG. 7B is a graph of epoxy 115 shear strength, or hardness, along the length of the pipe shown in FIG. 7A. Many elements shown in FIG. 7A are the same or substantially similar to those described above with respect to the pipe attachment assembly 100, 300, 500, 600, and a detailed description will not be repeated here. However, the pipe attachment assembly 700 may have an epoxy 115 with a shear modulus, or hardness, which varies along the axial length 125 of the pipe 105.

FIG. 7B is a plot 705 indicating several possible variations in the shear modulus or hardness of the epoxy 115 along the length of the pipe attachment assembly 700 shown in FIG. 7A. In one exemplary embodiment, illustrated by plotline 710, the shear modulus of the epoxy 115 is constant along the length of the pipe 105. Note that while plotline 710 is indicative of a low constant shear modulus along the entire length of the epoxy 115, in other embodiments the constant shear modulus may be a higher shear modulus.

In another exemplary embodiment, illustrated by plotline 720, the shear modulus of the epoxy 115 is constant at a first constant value along a first segment of the epoxy 115, and then is constant at a second and different constant value along a second segment of the epoxy 115. While not shown, the epoxy 115 may have three or more segments, each segment having a different shear modulus from the others, but the shear modulus being constant within each segment. In an embodiment, the epoxy 115 will have a higher shear modulus closer to the backup ring 128 and/or the flange 120, and a progressively lower shear modulus at distances further removed from the backup ring 128 and/or the flange 120.

In another exemplary embodiment, illustrated by plotline 730, the shear modulus of the epoxy 115 varies in a substantially linear fashion along the length of the pipe 105. In an embodiment, the epoxy 115 will have a higher shear modulus closer to the backup ring 128 and/or the flange 120, and a progressively lower shear modulus at distances further removed from the backup ring 128 and/or the flange 120

In another exemplary embodiment, illustrated by plotline 740, the shear modulus of the epoxy 115 varies in a substantially exponential fashion along the length of the pipe 105. In an embodiment, the epoxy 115 will have a higher shear modulus closer to the backup ring 128 and/or the flange 120, and a progressively lower shear modulus at distances further removed from the backup ring 128 and/or the flange 120.

Variations in the shear modulus of the epoxy 115 can be achieved by using different formulations of epoxy along the length, or by adding various degrees of hardening compounds along the length, as appropriate. Other means may be employed as well.

The variations in the shear modulus of the epoxy 115 may contribute to a more even and continuous distribution of shear stresses 140 along the end of the pipe attachment assembly 700. While FIG. 7A illustrates the epoxy 115 and the sleeve 110 as being external to the pipe 105, in an alternative embodiment the epoxy 115 and the sleeve 110 may be positioned internal to pipe 105.

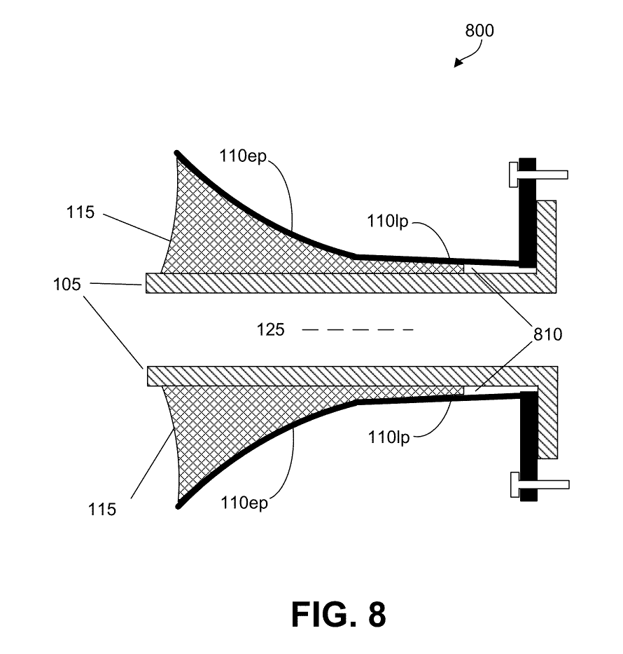

FIG. 8 illustrates another exemplary embodiment of a pipe attachment assembly 800. Many elements shown in FIG. 8 are the same or substantially similar to those described above with respect to the pipe attachment assemblies 100, 300, 500, 600, 700, and a detailed description will not be repeated here.

The pipe attachment assembly 800 may include a sleeve 110 with two or more component parts; for example, a first component part 1101p and a second component part 110ep. As shown in FIG. 8, the first part 1101p varies linearly in distance from the pipe 105 along the axial length 125 of the pipe 105, while the second part 110ep varies nonlinearly in distance from the pipe 105 along the axial length 125 of the pipe 105. Corresponding linear and nonlinear variations occur in the width of the epoxy 115 along the axial length 125 of the pipe 105. Note that the nonlinear variation has been exaggerated in the figure for purposes of illustration only.

The pipe attachment assembly 800 may also include a length along the pipe 105 where an annular gap 810 exists. The annular gap 810 is a region where no epoxy 115 is used to bond a portion of the sleeve 110 with the pipe 105, and where the sleeve 110 and the pipe 105 are not bonded.

Either or both elements, that is either of a sleeve 110 with two or more component parts 110ep, 1101p, and/or an annular gap 810 in the epoxy 115, may contribute to a more even and continuous distribution of stresses 140 through the epoxy 115 and between the pipe 105 and the sleeve 110.

In general, the system and method of the various embodiments may vary the width of the gap between pipe 105 and the sleeve 110, and/or may also vary the shear modulus of epoxy 115, as described above. The system and method employ these variations so that the effect of either variation, or both in combination is to ensure that the shear stress between the pipe 105 and the epoxy 115 remains acceptable and substantially even. By varying the gap and/or varying the epoxy properties, the result is a bend limiter 102 which makes the shear substantially uniform and within the shear limits of the bond between the pipe 105 and the epoxy 115.

FIG. 9 illustrates an exemplary mechanical joint 900 coupling a first pipe attachment assembly 100.1 with a second pipe attachment assembly 100.2. Without embodiment bend limiting elements there is an increased risk that pipe bending, tension or torsion may introduce excessive stress in the pipe 105 at or near stub ends 120, resulting in a pipe failure in this region or an undesired gap or breach at joint 900, such as a separation between the flanges 120 of the pipe 105 associated with element 100.1 and the pipe 105 associated with element 100.2.

With the bend limiting elements described in embodiments throughout this document, shear stresses on either or both of the first pipe attachment assembly 100.1 or the second pipe attachment assembly 100.2 are distributed in a substantially uniform fashion along the pipes 105 and also along the sleeves 110. The distribution of shear stresses significantly reduces the risk of undesired gaps or breaches at the joint 900 or pipe failures at or near stub ends 120.

FIG. 10 illustrates an exemplary mechanical joint 1000 coupling a pipe attachment assembly 100 with a mating surface 1005, which may for example be an opening or portal into a compartment, container, well, or similar fluid bearing enclosure. Without the embodiment bend limiting elements there is an increased risk that pipe bending, tension or torsion may introduce excessive stress in the pipe 105 at or near stub ends 120 resulting in a pipe failure in this region or an undesired gap or breach at joint 900, for example by inducing a separation between the flanges 120 of the pipe 105 and mating surface 1005.

With the embodiment bend limiting elements positioned on a pipe 105 at an attachment, shear stresses on the pipe attachment assembly 1000 are distributed in a substantially uniform fashion along the pipe 105 and also along the sleeve 110. The distribution of shear stresses significantly reduces the risk of undesired gaps or breaches at the joint 1000 900 or pipe failures at or near stub ends 120.

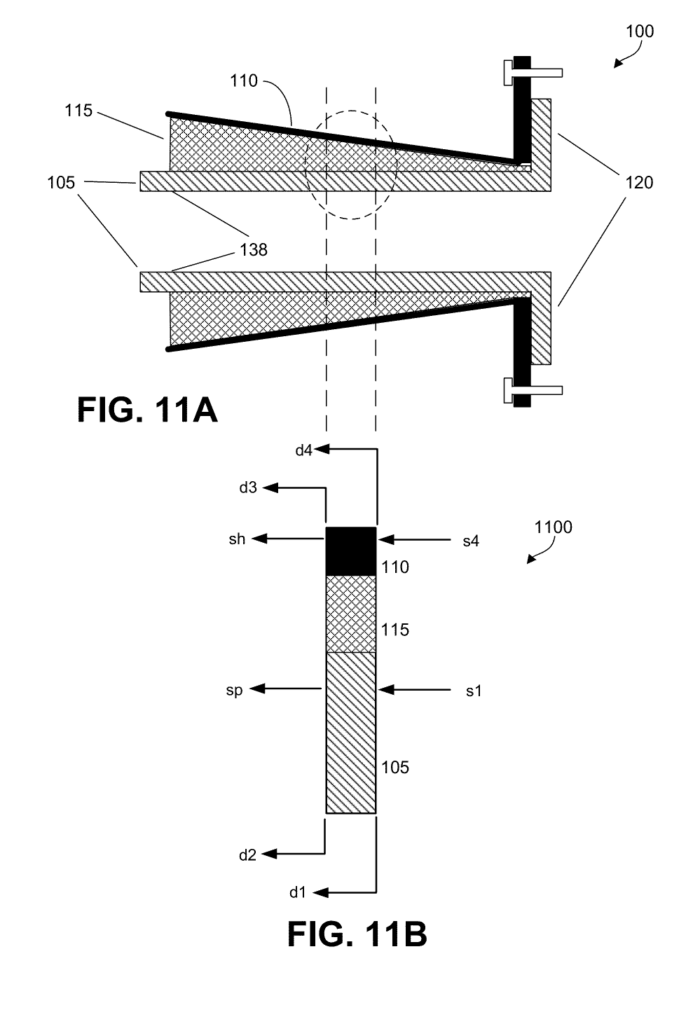

FIG. 11A is an illustration of an embodiment assembly and FIG. 11B illustrates elements useful for modeling of distribution of shear stresses in the embodiment illustrated in FIG. 11A.

A pipe termination 100 loaded as shown in FIG. 1C with a downward shear load 150.2 or a counterclockwise moment 157 results in a moment applied to the pipe 105. In such a situation, the upper portion of the pipe 105 is in tension and the lower portion of the pipe is in compression. A schematic of the pipe modeled is shown in FIG. 11A. Preliminary analysis modeled an upper surface of the pipe as a pair of flat plates bonded by an epoxy and neglected the rest of the pipe. In that modeling, the upper plate is steel, the lower plate is HDPE, and the gap between is variable.

The system was modeled using finite element methods. Each element consisted of a one inch wide strip of HDPE 105, a strip of epoxy 115, and steel sleeve 110. The parameters considered were the stresses and deflections on each end of the sleeve and the HDPE. FIG. 11B shows a free body diagram of a single element. The positive direction is to the left and points towards the free end of the system (directed from the flange 120 towards the point 138). The stresses s1 and s4 are unknown reactions ultimately imposed by the fixed end (the flange end 120) while sh and sp are known stresses derived from the tension placed on the free end of the pipe (from the direction of point 138). The deflections d1 through d4 are absolute measurements of the change in position of each end of the pipe 105 and sleeve 110 due to elongation. The free end, represented by d2 and d3 are unknown while d1 and d4 are inferred from the rigid position of the fixed end.

Modeling the steel and epoxy as linearly elastic materials and the HDPE as a non-linear elastic material created relations between the eight parameters above. Four equations were derived and are presented below.

$$s 1 \to \frac{- sp \cdot Tp - Eg \cdot \frac{L}{Tg} \cdot d 3 + Eg \cdot \frac{L}{Tg} \cdot d 2}{Tp}$$

$$s 4 \to \frac{- sh \cdot Th - Eg \cdot \frac{L}{Tg} \cdot d 2 + Eg \cdot \frac{L}{Tg} \cdot d 3}{Th}$$

$$d 1 \to \frac{- sp \cdot Tp + Ep \cdot \frac{Tp}{L} \cdot d 2 - Eg \cdot \frac{L}{Tg} \cdot d 3 + Eg \cdot \frac{L}{Tg} \cdot d 2}{Ep \cdot Tp} \cdot L$$

$$d 4 \to \frac{- sh \cdot Th - Eg \cdot \frac{L}{Tg} \cdot d 2 + Eg \cdot \frac{L}{Tg} \cdot d 3 + Eh \cdot \frac{Th}{L} \cdot d 3}{Eh \cdot Th} \cdot L$$

The additional variables in the equations are defined as follows: Tp, Tg, and Th refer to the thickness of the pipe, epoxy, and steel respectively; Ep, and Eh refer to the tangent modulus of elasticity of the pipe and steel respectively; Eg refers to the shear modulus of the epoxy; and L refers to the length of the element.

The limiting factor in the design of the system is the maximum allowable shear stress in the epoxy. A preliminary value of 295 psi may be used as the ultimate shear strength of the epoxy based on literature provided by Reltek (“RELTEK LLC, 23450 Circadian Way, Santa Rosa, CA 95407”) about its BONDiT™ B-45 epoxy. The maximum allowable stress may be 150 psi to give a safety factor of 2. Two parameters affect the shear stress in the epoxy: the gap between the pipe and the sleeve; and the shear modulus of the epoxy. Several combinations may be considered in order to determine the most efficient configuration. An efficient configuration may be defined as one with a minimum gap and length.

In a first embodiment, the pipe attachment assembly may feature a linearly increasing gap between the pipe and the sleeve. In this embodiment, the steel sleeve represents a cone that would steadily increase the gap for the epoxy to fill. As described above, this gap setup may be configured to result in a steadily decreasing epoxy stress.

In a second embodiment, the pipe attachment assembly may feature two cones and a pipe. In this embodiment, the steel sleeve represents two cones rather than a single cone. This allows the gap to narrow faster near the free end yet still remain under 150 psi epoxy stress limit. A short segment at the fixed end with a constant gap further increased the efficiency of the system. This gap setup resulted in 2 sections of steadily decreasing epoxy stress with a sudden jump in stress at the interface of the two cones. The average stress in the epoxy was higher than with the linearly increasing gap.

In a third embodiment, the pipe attachment assembly may feature an exponential gap. In this embodiment, an exponentially increasing gap may be tailored to match the stress increase in the epoxy near the free end. This gap setup results in a nearly constant epoxy stress of 150 psi.

In a fourth embodiment, the pipe attachment assembly may feature a single epoxy used throughout the gap between the pipe and the sleeve.

In a fifth embodiment, the pipe attachment assembly may feature two epoxies used in the gap. Near the fixed end, where deflections are relatively small, a stiffer epoxy may be used. Near the free end, where deflections are larger, a more flexible epoxy may be used. Using two epoxies improved the efficiency of all gap setups.

The results of analyses of these embodiments are presented in the table below.

| | Free End | Fixed End | Maximum | System |
|---|---|---|---|---|
| | Modulus | Modulus | Gap | Length |
| Gap Setup | [psi] | [psi] | inch | inch |
| Linearly Increasing | 800 | 800 | 1.69 | 30 |
| Linearly Increasing | 800 | 1600 | 1.50 | 24 |
| 2 Cones and a Pipe | 800 | 800 | 1.28 | 21 |
| 2 Cones and a Pipe | 800 | 1600 | 1.28 | 20 |
| Exponential | 800 | 800 | 1.22 | 20 |
| Exponential | 800 | 1600 | 1.20 | 19 |

An epoxy bonded bend limiter to relieve flange tension appears feasible. Nothing in the geometry or force balance indicates extraordinary challenges in the application of such a system. The gap between the sleeve and the pipe has the greatest effect on the size of the pipe attachment system. Using more than one epoxy can also help reduce the size of the pipe attachment system.

Elements herein are sometimes described in terms of a geometric shape known as a “frustum.” FIGS. 12A-12C illustrates alternative configurations of a reinforcing member generally referred to herein as a frustum. Element 1205 shown in FIG. 12A is a cone. Element 1205.D is a planar surface bisecting cone 1205 and parallel element 1210 in FIG. 12B. For purposes of this document, a cone with curved sides can also be used as a basis to define a frustum. As shown for example with element 1220 in FIG. 12C, then, a frustum may have curved sides rather than straight sides, the curved sides extending between a wider horizontal base and a relatively narrower, parallel horizontal top of the frustum.

While the figures and the foregoing description describe embodiments in which the sleeve fully encircles an exterior or interior surface of the pipe, sleeve that partially encircle the pipe may be used in applications in which applied forces will be limited to particular directions. In some situations a pipe attachment may be subject to bending forces limited to a narrow angle, and not subject to bending over the remaining angles about the pipe center line. In such situations, the sleeve may be configured as a section of a frustum, with the sleeve positioned only within the angles of the pipe about which bending stresses are anticipated. Such embodiments will be configured substantially as shown in the figures and described above, with the exception that the sleeve and epoxy will not extend completely around or within the pipe.

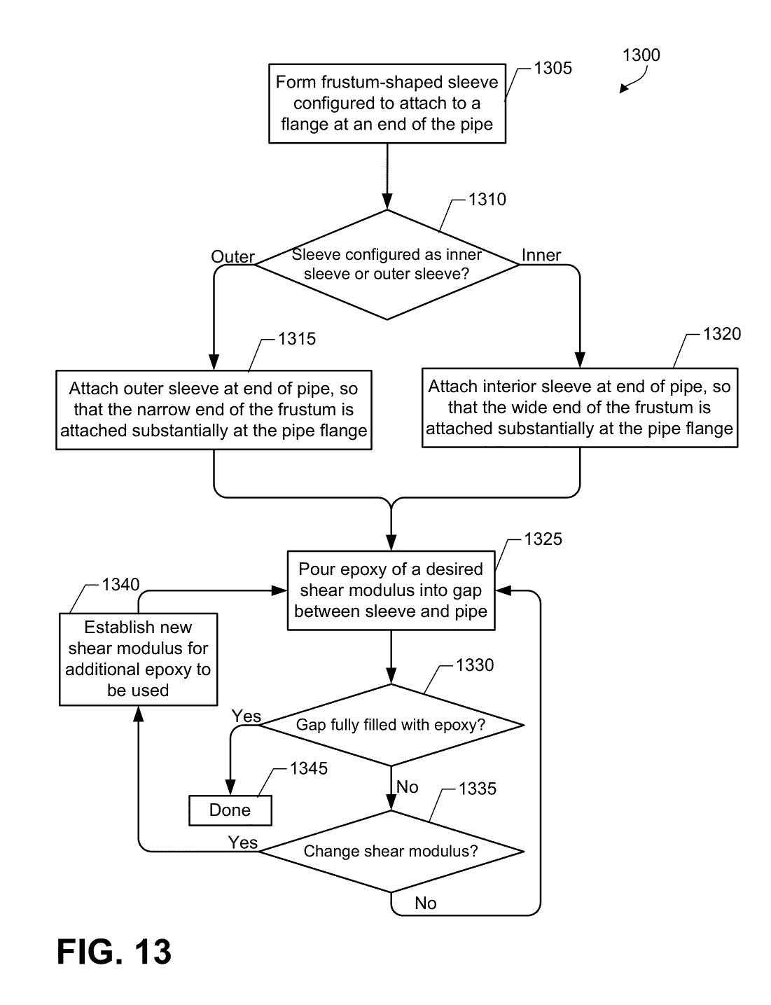

FIG. 13 is a flow chart of an exemplary method 1300 for constructing a system for distributing shear stresses in a pipe.

The method begins by forming a frustum shaped sleeve that is configured to attach to a flange end of a pipe. The sleeve is comprised of a material which is stiffer than the pipe, and may for example be a metal, such as steel, titanium or aluminum, or fiberglass.

In decision step 1310, a determination is made as to whether the sleeve is to be configured as an inner sleeve placed inside the pipe or as an outer sleeve to surround the pipe.

If an outer sleeve is to be used, then outer sleeve is attached to the flange or substantially near the flange at the end of the pipe in step 1315, so that the narrow end of the frustum is attached to the bend limiter flange.

If the sleeve is to be configured as an inner sleeve, the inner sleeve is attached to the flange or substantially near the flange at the end of the pipe in step 1320, so that the wide end of the sleeve of frustum is attached to the bend limiter flange.

In step 1325, an epoxy of a desired shear modulus is poured into the gap which exists between the sleeve and the pipe.

In step 1330 the epoxy pouring process may be monitored to determine whether the gap has been completely filled to the desired length along the pipe. If so, the fabrication operation concludes at step 1345.

If the gap has not been fully filled, a determination is made as to whether the shear modulus of the epoxy should be changed. If the shear modulus of the epoxy should not be changed, the epoxy pouring step 1325 continues.

If at step 1335 the shear modulus used for further filling of the gap is to be changed, a different epoxy with a different shear modulus may be selected in step 1340, and poured into the remaining gap in step 1325.

In an alternative embodiment, the epoxy may be attached to either the interior or the exterior of the pipe, using some kind of molding method or other manufacturing method, before the sleeve is in place area. After the epoxy is in place the sleeve may be attached (e.g., by epoxy bond) to the remaining exposed surface of the epoxy, as well as the sleeve being attached to the flange of the pipe.

While various embodiments of the present system and method have been described above, it should be understood that they have been presented by way of example, and not limitation. It will be apparent to persons skilled in the relevant art(s) that various changes in form and detail can be made therein without departing from the spirit and scope of the present system and method. Thus, the present system and method should not be limited by any of the above described exemplary embodiments, but should be defined only in accordance with the following claims and their equivalents.

In addition, it should be understood that the figures illustrated in the attachments, which highlight the structure, functionality and advantages of the present system and method, are presented for example purposes only. The architecture of the present system and method is sufficiently flexible and configurable, such that it may be implemented and utilized in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present system and method in any way.

What is claimed is:

1. A pipe attachment assembly, comprising:
a sleeve positioned at an end of a pipe, wherein:
the sleeve surrounds an exterior of the pipe;
the sleeve is of a higher stiffness than the pipe;
the sleeve is shaped substantially as a frustum;
the sleeve is arranged in parallel with the pipe, a central longitudinal axis of the sleeve and a central longitudinal axis of the pipe being substantially coincident; and
the sleeve is positioned so as to form a gap running a length of the sleeve between the exterior of the pipe and the sleeve; and
an elastomeric bonding material (“epoxy”) in the gap between the sleeve and the pipe, the pipe and the sleeve both bonded to the epoxy.

2. The pipe attachment assembly of claim 1, wherein a first end of the sleeve which is lesser in diameter than a second end of the sleeve is placed substantially coincident with a terminus of the end of the pipe.

3. The pipe attachment assembly of claim 1, wherein the pipe comprises a polymer.

4. The pipe attachment assembly of claim 1, wherein the sleeve comprises at least one of a metal and fiber glass.

5. The pipe attachment assembly of claim 4, wherein the metal comprises at least one of steel, titanium, and aluminum.

6. The pipe attachment assembly of claim 1, wherein the epoxy has a bond strength high enough to maintain a bond with both the pipe and the sleeve when the pipe is exposed to stretching forces, compression forces, bending forces, or torsional shear forces.

7. The pipe attachment assembly of claim 6, wherein the epoxy comprises a material having a shear bond strength on the order 300 psi or greater.

8. The pipe attachment assembly of claim 1, wherein the sleeve is configured so that the gap between the sleeve and the pipe varies linearly along the length of the pipe attachment assembly.

9. The pipe attachment assembly of claim 1, wherein the sleeve is configured so that the gap between the sleeve and the pipe varies non-linearly along the length of the pipe attachment assembly.

10. The pipe attachment assembly of claim 9, wherein sleeve is configured so that the gap between the sleeve and the pipe has a substantially exponential shape.

11. The pipe attachment assembly of claim 1, wherein the sleeve is configured so that the gap between the sleeve and the pipe varies linearly along a portion of the length of the pipe attachment assembly and non-linearly along a remainder of the length of the pipe attachment assembly.

12. The pipe attachment assembly of claim 1, wherein the epoxy is configured so that a tension or moment on the pipe induces a near uniform shear strain in the epoxy, whereby a near uniform shear load is induced on the pipe.

13. The pipe attachment assembly of claim 1, wherein the shear modulus of the epoxy varies along the length of the pipe attachment assembly.

14. The pipe attachment assembly of claim 1, wherein the sleeve comprises a plurality of segments along the length of the pipe attachment assembly, each segment separated from an adjacent segment by a longitudinal separation.

15. The pipe attachment assembly of claim 14, wherein each respective segment of the plurality of segments is joined to a base of the pipe attachment assembly by a respective hinge.

16. The pipe attachment assembly of claim 1, wherein the sleeve comprises a plurality of respective segments consecutive to each other, each segment having a different curvature than each adjacent segment.

17. The pipe attachment assembly of claim 1, wherein the pipe comprises HDPE.

18. The pipe attachment assembly of claim 1, wherein the sleeve does not completely encircle the pipe.
